(19) United States
(12) Patent Application Publication
(10) Pub. No.: US 2002/0074397 A1
(43) Pub. Date: Jun. 20, 2002

(54) Vending machine with age verification means

(76) Inventor: Frederick L. Matthews, Grand Rapids, MI (US)

Correspondence Address: Kaardal & Associates, PC, Attn: Ivar M. Kaardal, 3500 South First Avenue Circle, Suite 250, Sioux Falls, SD, 57105-5802, US

(21) Appl. No.: 09/737,794

(22) Filed: Dec. 15, 2000

(51) Int. Cl. G06F 7/08

(52) U.S. Cl. 235/381

(57) ABSTRACT

A vending machine is provided that includes an identification card for carrying by a holder of the card, with the identification card having an age and personal identification number of the holder of the identification card being encoded on the identification card. A vending machine has a housing with an interior, and the vending machine includes a dispensing mechanism for selectively dispensing products upon actuation of the dispensing mechanism. A money acceptor is provided for accepting money for purchasing a product. A card reader is provided for reading the age and personal identification number encoded on the identification card. A keypad is provided for allowing the inputting of information including the personal identification number and an address corresponding to a product to be dispensed. A control mechanism is provided for controlling operation of the vending machine, and the control mechanism is operatively connected to the money acceptor, the card reader, the keypad, and the dispensing mechanism. The control mechanism is adapted to detect successful performance of age verifying actions and actuate the dispensing mechanism to dispense a product upon the detection of the successful performance of the age verifying actions. Preferably, successful performance of the age verifying actions includes inserting the identification card into the card reader, and entry of the personal identification number on the keypad.

### REFERENCE TO RELATED APPLICATION

This application is a substitute for application Ser. No. 09/086,451, filed May 28, 1998.

### BACKGROUND OF THE INVENTION

1. Field of the Invention

The present invention relates to age verification systems and more particularly pertains to a new vending machine with age verification means for verifying an age of a customer at a vending machine prior to a purchase.

2. Description of the Prior Art

The use of age verification systems is known in the prior art. Further, vending machines that restrict the sale of products to underage or otherwise unqualified customers buyers are also known. Typically, these known machines restrict access to all of the products offered by the vending machine, whether or not all of the products require restricted access. Thus, every potential customer attempting to purchase a product from the machine must meet the minimum criteria for sale (such as a minimum age), even if some of the products in the machine can be sold to underage customers. Thus, if it is desired to sell products to persons not meeting the restrictive criteria, an additional vending machine must be used for those unrestricted products. This situation requires additional investment in machines for a particular location, or requires that unrestricted sale products be needlessly withheld from sale to qualified customers if only a prior art restricted access vending machine is used.

None of the known prior art vending machines are capable of discriminating between restricted sale products and non-restricted sale products, as well as being capable of discriminating between qualified and unqualified (e.g., under legal buying age) customers.

In these respects, the vending machine with age verification means according to the present invention substantially departs from the conventional concepts and designs of the prior art, and in so doing provides an apparatus primarily developed for the purpose of verifying an age of a customer at a vending machine prior to a purchase.

### SUMMARY OF THE INVENTION

In view of the foregoing disadvantages inherent in the known types of age verification systems now present in the prior art, the present invention provides a new vending machine with age verification means construction wherein the same can be utilized for verifying an age of a customer at a vending machine prior to a purchase.

The general purpose of the present invention, which will be described subsequently in greater detail, is to provide a new vending machine with age verification means apparatus and method which has many of the advantages of the age verification systems mentioned heretofore and many novel features that result in a new vending machine with age verification means which is not anticipated, rendered obvious, suggested, or even implied by any of the prior art age verification systems, either alone or in any combination thereof.

To attain this, the present invention generally comprises an identification card for carrying by a holder of the card, with the identification card having an age and personal identification number of the holder of the identification card being encoded on the identification card. A vending machine has a housing with an interior, and the vending machine includes dispensing means for selectively dispensing products upon actuation of the dispensing means. A money acceptor is provided for accepting money for purchasing a product. A card reader is provided for reading the age and personal identification number encoded on the identification card. A keypad is provided for allowing the inputting of information including the personal identification number and an address corresponding to a product to be dispensed. Control means is provided for controlling operation of the vending machine, and the control means is operatively connected to the money acceptor, the card reader, the keypad, and the dispensing means. The control means is adapted to detect successful performance of age verifying actions and actuate the dispensing means to dispense a product upon the detection of the successful performance of the age verifying actions. Preferably, successful performance of the age verifying actions includes inserting the identification card into the card reader, and entry of the personal identification number on the keypad.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new vending machine with age verification means apparatus and method which has many of the advantages of the age verification systems mentioned heretofore and many novel features that result in a new vending machine with age verification means which is not anticipated, rendered obvious, suggested, or even implied by any of the prior art age verification systems, either alone or in any combination thereof.

It is another object of the present invention to provide a new vending machine with age verification means that may be easily and efficiently manufactured and marketed.

It is a further object of the present invention to provide a new vending machine with age verification means that is of a durable and reliable construction.

An even further object of the present invention is to provide a new vending machine with age verification means which is susceptible of a low cost of manufacture with regard to both materials and labor, and which accordingly is then susceptible of low prices of sale to the consuming public, thereby making such vending machine with age verification means economically available to the buying public.

Still yet another object of the present invention is to provide a new vending machine with age verification means which provides in the apparatuses and methods of the prior art some of the advantages thereof, while simultaneously overcoming some of the disadvantages normally associated therewith.

Still another object of the present invention is to provide a new vending machine with age verification means for verifying an age of a customer at a vending machine prior to a purchase.

Even still another object of the present invention is to provide a new vending machine that includes an identification card for carrying by a holder of the card, with the identification card having an age and personal identification number of the holder of the identification card being encoded on the identification card. A vending machine has a housing with an interior, and the vending machine includes dispensing means for selectively dispensing products upon actuation of the dispensing means. A money acceptor is provided for accepting money for purchasing a product. A card reader is provided for reading the age and personal identification number encoded on the identification card. A keypad is provided for allowing the inputting of information including the personal identification number and an address corresponding to a product to be dispensed. Control means is provided for controlling operation of the vending machine, and the control means is operatively connected to the money acceptor, the card reader, the keypad, and the dispensing means. The control means is adapted to detect successful performance of age verifying actions and actuate the dispensing means to dispense a product upon the detection of the successful performance of the age verifying actions. Preferably, successful performance of the age verifying actions includes inserting the identification card into the card reader, and entry of the personal identification number on the keypad.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front view of a new vending machine with age verification means according to the present invention.

FIG. 2 is a flow chart showing the general operation of the present invention.

FIG. 3 is a schematic diagram of the present invention.

### DESCRIPTION OF THE PREFERRED EMBODIMENT

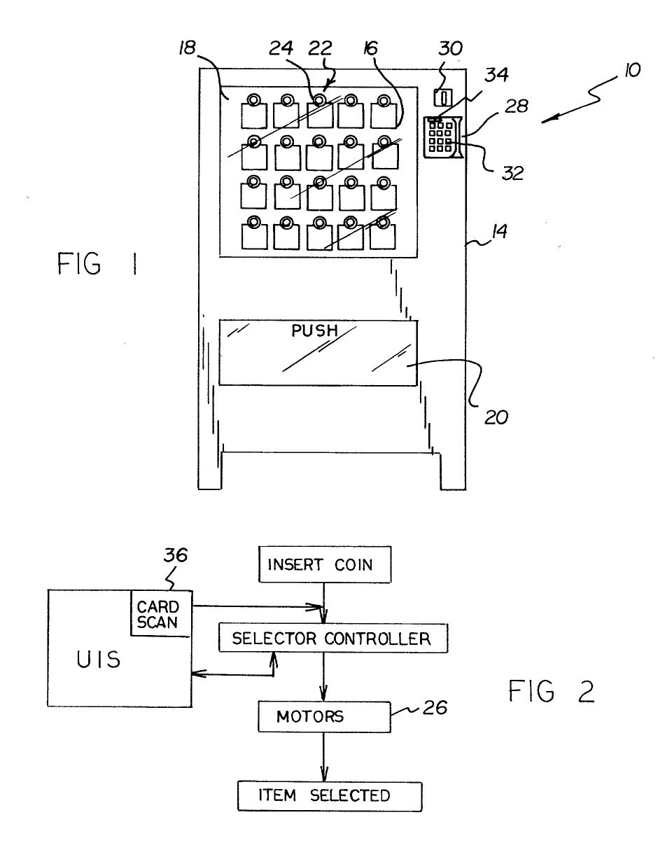

With reference now to the drawings, and in particular to FIGS. 1 through 3 thereof, a new vending machine with age verification means embodying the principles and concepts of the present invention and generally designated by the reference numeral 10 will be described.

The present invention, designated as numeral 10, includes a plurality of identification cards each with a magnetic strip mounted thereon. The magnetic strip of each identification card contains a magnetically stored age of an owner of the identification card. It should be noted that the identification card may take any form, including a driver's license. Significantly, the identification card may have a personal identification number of the owner that is magnetically encoded or stored on the card.

FIG. 1 shows a vending machine housing 14 including a generally rectangular configuration defined by a front face, a rear face, a top face, a bottom face and a pair of side faces. An interior face is thus defined with a plurality of shelves 16 mounted therein each with an open front. The front face has a window 18 for viewing the shelves of the housing and a door 20 mounted thereon below the window and the shelves. The door allows access to a tray within the interior space of the housing below the shelves.

Situated within the vending machine housing is a dispensing assembly 22 including a plurality of helical rods 24 rotatably mounted on the shelves. Each helical rod has an outboard end situated adjacent to the open front of the corresponding shelf. An inboard end of each helical rod has a motor 26 mounted thereon for rotating the same one single rotation upon the actuation thereof. It should be noted that each of the helical rods and corresponding motor has an address associated therewith.

Situated on the shelves of the vending machine housing is a first set of products for being sold to minors. Associated therewith is a second set of products for being sold only to adults. The first and second sets of products remain in communication with the corresponding helical rods for being dispensed to the tray upon the actuation of the associated motor.

With reference again to FIG. 1, a control panel 28 is mounted on the front face of the vending machine housing. The control panel includes a money acceptor 30 for accepting money. Also included is a keypad 32 for allowing the inputting of one of the addresses. For displaying various messages, a display 34 is provided. Next provided is a card reader 36 for reading the magnetically stored age from one of the identification cards upon the same being swiped through an associated vertically oriented slot. Also, the card reader is adapted to read the personal identification number that is encoded on the card.

Connected between the control panel and the motors is a control means 38. Such control means is adapted to actuate the motor associated with the first set of products upon just the acceptance of money by the money acceptor in combination with the entrance of an associated address via the keypad. By this function, a minor may purchase one of the first set of products without age verification.

The control means is further adapted to continuously display a message prompting the swiping of an identification card. Upon an age read from a swiped identification card being at least a predetermined age, namely 18 or 21, the control means is adapted to actuate the motor associated with the second set of products. Preferably, before actuating the motor, and for the purpose of verifying that the person using the identification card is the legitimate owner of the card, the control means prompts the potential customer to enter, using the keypad, the appropriate personal identification number for the owner of the identification card. (The timer may provide a predetermined delay time period for the personal identification number to be entered by the potential customer.) The personal identification number entered by the potential customer is compared to the personal identification number encoded on the card to see if the numbers match. If the personal identification numbers match, the potential customer is permitted to purchase one of the second set of products. It should be noted that such actuation is carried out only upon the acceptance of money by the money acceptor in combination with the entrance of an address via the keypad that is associated with the desired product.

Upon the unsuccessful verification of the age of the customer, the messages “You must be at least—YRS of age to purchase” and “Please make another selection” are depicted. It should be noted that the control means employs a timer to allow the dispensing of the second set of products only if the proper money is inserted and the product is selected within a predetermined time period from the successful verification of the age of the user.

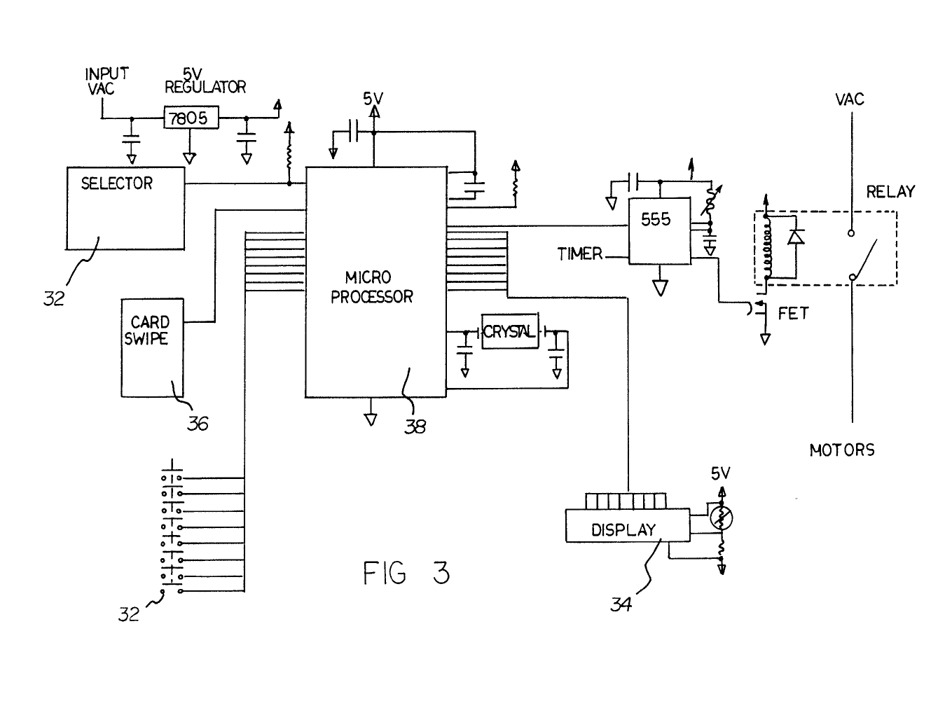

To accomplish the foregoing function, the control means preferably employs a microprocessor with a crystal to afford the aforementioned timer function. See FIG. 3. Further, a 555 timer configured to operate as a one-shot multivibrator is connected to the microprocessor to afford the motor with a pulse of a predetermined duration so as to effect a complete revolution of the associated helix. Associated with the one-shot multivibrator is a relay that is employed to afford a sufficient voltage to the motor for the predetermined duration. As shown in FIG. 3, a FET is utilized to drive the relay. By this structure, the microprocessor effectively works to selectively preclude the operation of the motors unless certain criteria are met.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An age verifying vending system comprising:
an identification card for carrying by a holder of the card, the identification card having an age and personal identification number of the holder of the identification card being encoded on the identification card;
a vending machine having a housing with an interior, and the vending machine including:
dispensing means for selectively dispensing products upon actuation of the dispensing means;
a money acceptor for accepting money for purchasing a product;
a card reader for reading the age and personal identification number encoded on the identification card;
a keypad for allowing the inputting of information including the personal identification number and an address corresponding to a product to be dispensed; and
control means for controlling operation of the vending machine, the control means being operatively connected to the money acceptor, the card reader, the keypad, and the dispensing means, the control means being adapted to detect successful performance of age verifying actions and actuate the dispensing means to dispense a product upon the detection of the successful performance of the age verifying actions.

2. The system of claim 1 wherein successful performance of the age verifying actions includes inserting the identification card into the card reader, and entry of the personal identification number on the keypad.

3. The system of claim 1 that the vending machine additionally comprises a display for displaying various messages thereon.

4. The system of claim 1 wherein the housing has a plurality of shelves mounted therein, each shelf having an open front.

5. The system of claim 4 wherein the housing of the vending machine has a front face with a window for viewing the shelves of the housing, and a door mounted on the housing below the window and the shelves.

6. The system of claim 1 wherein the dispensing means comprises a dispensing assembly including a plurality of helical rods rotatably mounted on the housing.

7. The system of claim 6 wherein a first plurality of helical rods is adapted for dispensing a first set of unrestricted products and a second plurality of helical rods is adapted for dispensing a second set of restricted products.

8. The system of claim 7 additionally comprising a first set of unrestricted products for being sold to minors and adults, the first set of restricted products being situated in communication with a first plurality of helical rods for dispensing one of the first set of unrestricted products upon actuation of one of the first plurality of helical rods, and a second set of restricted products for being sold only to adults, the second set of restricted products being situated in communication with the second plurality of helical rods for dispensing one of the second set of restricted products upon actuation of one of the second plurality of helical rods.

9. The system of claim 8 wherein the control means is adapted to actuate one of the first plurality of helical rods for dispensing one of the first set of products upon acceptance of money by the money acceptor in combination with entry of a product address on the keypad.

10. The system of claim 9 additionally comprises a display for displaying various messages thereon, wherein the control means is adapted to display a message prompting swiping of the identification card through the card reader, the control means being adapted to actuate one of the second plurality of helical rods for dispensing one of the second set of products only upon an age read from the identification card being at least a predetermined age, the acceptance of money by the money acceptor, and the entrance of an address via the keypad which is associated with one of the second plurality of helical rods.

11. The system of claim 6 wherein each of the helical rods has an outboard end situated adjacent to an open front of a shelf and an inboard end with a motor mounted thereon for rotating the helical rod approximately one single rotation upon the actuation of the motor.

12. The system of claim 1 wherein the identification card has a magnetic strip coupled thereto for magnetically storing the encoded age and personal identification number of the holder of the identification card.
